(19) United States
(12) Patent Application Publication
(10) Pub. No.: US 2007/0127568 A1
(43) Pub. Date: Jun. 7, 2007

(54) DEVICE AND METHOD FOR EXTRACTING CONTOUR OF MOVING OBJECT

(75) Inventor: Koji KITAYAMA, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/558,172

(22) Filed: Nov. 9, 2006

(30) Foreign Application Priority Data
Nov. 10, 2005 (JP) 2005-326434

(51) Int. Cl. H04N 7/12; H04N 11/02

(52) U.S. Cl. 375/240.08; 375/240.16

(57) ABSTRACT

A device includes: a motion vector decoder that decodes the encoded motion vector information; a motion vector classification unit that classifies a moving direction of the motion vector into one of a plurality of directional ranges that are preliminarily defined; a different direction image block extractor that extracts the image block having the classified directional range different from the peripheral image blocks; an image block connector that connects consecutive image blocks, when any image blocks in the same directional range exist consecutively in the extracted image block; and a contour extractor that extracts the line spanning the outermost periphery of the connected image blocks as the contour data.

### RELATED APPLICATION

The present disclosure relates to the subject matter contained in Japanese Patent Application No. 2005-326434 filed on Nov. 10, 2005, which is incorporated herein by reference in its entirety.

### FIELD

The present invention relates to a device and a method for extracting a contour of an image area encompassing a moving object existing in the compressed and encoded video image data.

### BACKGROUND

In television broadcast, it is a common practice that only an image portion moving in the video image is picked up and displayed as another image. For example, only an image of a moving player or ball in the broadcast image of a ball game such as soccer is picked up, and its motion is displayed. At this time, it is required that the contour of the image area is extracted to pick up the image.

Conventionally, as a method for extracting the contour of the moving object from the video image, the video image data is inputted consecutively, the background and the moving direction of concerned object between plural consecutive image data are acquired for every small partition, the video image data is classified into plural image data in accordance with the similarity of the moving direction in each small partition, and an area where the moving object exists is estimated and extracted from the classified image data (e.g., refer to JP-A-2001-109891).

However, there is a problem that if the area where the moving object exists is extracted from the compressed and encoded video image data by the above method in the digital television broadcast or the like encoded in accordance with the MPEG-2 standard, it is required that the compressed and encoded video image data is once decoded, and the processing amount and time required for decoding data are significant.

### SUMMARY

According to one aspect of the invention, there is provided a device for extracting contour of a moving object included in a video image. The device includes: a motion vector decoder that decodes a motion vector on an image block basis in accordance with motion vector information that is generated in compressing and encoding the video image; a motion vector classification unit that classifies a moving direction of the image block represented by the motion vector into one of a plurality of directional ranges that are preliminarily defined; a different direction image block extractor that extracts the image block having the classified directional range different from the peripheral image blocks; an image block connector that connects consecutive image blocks, when any image blocks in same directional range exist consecutively in the extracted image block; and a contour extractor that extracts the line spanning the outermost periphery of the connected image blocks as contour data that indicates contour of the moving object.

### BRIEF DESCRIPTION OF THE DRAWINGS

In the accompanying drawings:

FIG. 1 is a block diagram showing a configuration example of a device according to an embodiment of the present invention;

FIG. 2 is a flowchart showing a method for classifying the motion vector into quadrants according to the embodiment of the invention;

FIG. 3 is a view for explaining the quadrants classified in FIG. 2;

FIG. 4 is a flowchart showing a method for further classifying the motion vector within the quadrant into directional ranges according to the embodiment of the invention;

FIG. 5 is a view for explaining the directional ranges classified in FIG. 4;

FIG. 6 is a view showing the relationship between the classification of the motion vector and the direction of motion vector according to the embodiment of the invention;

FIG. 7 is a view showing an example of motion vector in each image block of the image containing the moving object;

FIG. 8 is a view showing an example of classifying the motion vector of FIG. 7 into directional ranges according to the embodiment of the invention;

FIG. 9 is a view showing an example of connecting the image blocks having different moving direction from the peripheral image blocks in this embodiment;

FIG. 10 is a view showing an example of extracting the contour of the image containing the moving object in this embodiment;

FIG. 11 is a view showing another example of motion vector in each image block of the image containing the moving object;

FIG. 12 is a view showing an example of classifying the motion vector of FIG. 11 into directional ranges in this embodiment;

FIG. 13 is a view showing an example of connecting the image blocks having different moving direction from the peripheral image blocks in this embodiment; and

FIG. 14 is a view showing an example of extracting the contour of the image containing the moving object in this embodiment.

### DETAILED DESCRIPTION OF THE EMBODIMENT(S)

An embodiment of the present invention will be described below with reference to the drawings.

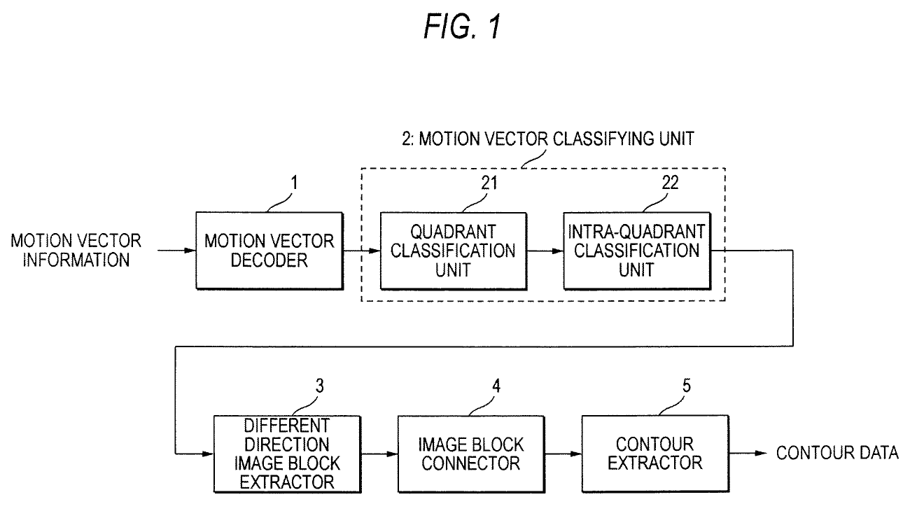

FIG. 1 is a block diagram showing a configuration example of a device according to the embodiment of the invention.

The device of this embodiment includes: a motion vector decoder 1 that decodes a motion vector on an image l$ block basis by inputting the encoded motion vector information; a motion vector classification unit 2 that classifies a moving direction of the image block represented by the decoded motion vector into any one of eight directional ranges that are preliminarily defined with a classification number appended; a different direction image block extractor 3 that extracts an image block having a different classification number from the peripheral image blocks by comparing the classification number appended in the moving direction of each image block with the classification numbers of the peripheral image blocks; an image block connector 4 that connects consecutive image blocks, when the image blocks having the same classification number exist consecutively in the extracted image block; and a contour extractor 5 that extracts the line spanning the outermost periphery of the connected image blocks as the contour data.

The motion vector classification unit 2 includes: a quadrant classification unit 21 that classifies the motion vector decoded by the motion vector decoder 1 into four quadrants A, B, C and D according to a combination of positive and negative of a horizontal component value and a vertical component value of the motion vector; and an intra-quadrant classification unit 22 that classifies the motion vector classified into each quadrant into further four directional ranges a, b, c and d according to the magnitude of a ratio of the absolute value of the horizontal component value and the absolute value of the vertical component value.

In the classification of the quadrant classification unit 21, the horizontal component value and the vertical component value are treated as positive, when they are zero.

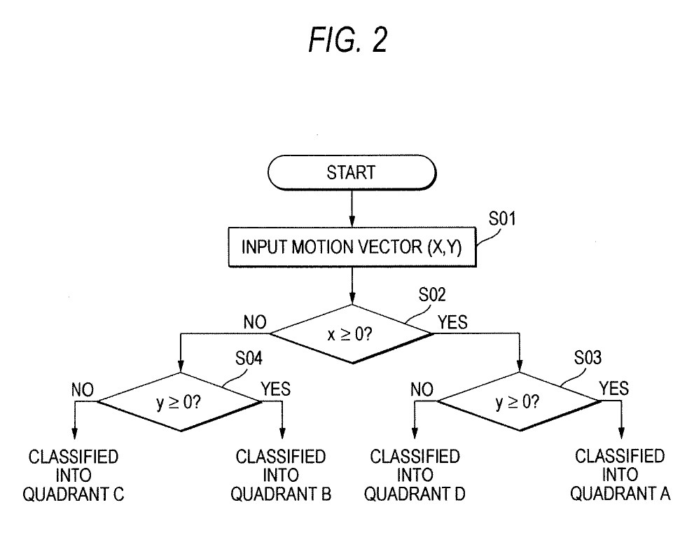

FIG. 2 is a flowchart showing a procedure of a method for classifying the motion vector into quadrants in the quadrant classification unit 21.

If the motion vector (x,y) represented by the horizontal component value x and the vertical component value y is inputted (step S01), it is checked whether or not x is positive (x≧0) (step S02).

If x≧0 (YES), it is checked whether or not y is positive (y≧0). If y≧0 (YES), the motion vector is classified into the quadrant A, or if not y≧0 (NO), the motion vector is classified into the quadrant D (STEP S03).

Also, if not x≧0 (NO) at step S02, it is checked whether or not y is positive (y≧0). If y≧0 (YES), the motion vector is classified into the quadrant B, or if not y≧0 (NO), the motion vector is classified into the quadrant C (step S04).

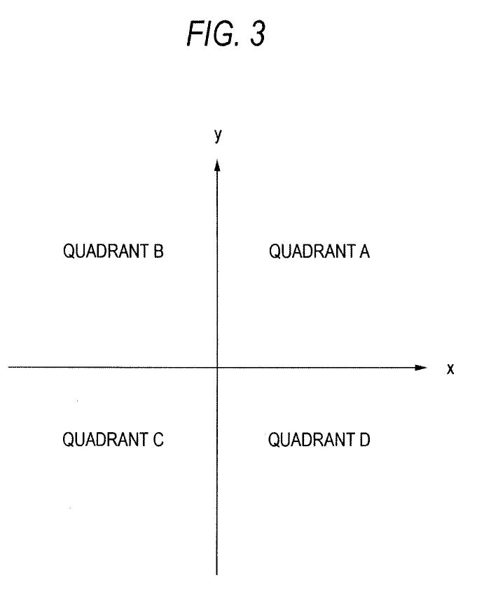

FIG. 3 shows the quadrants classified in FIG. 2 in the x,y coordinate system.

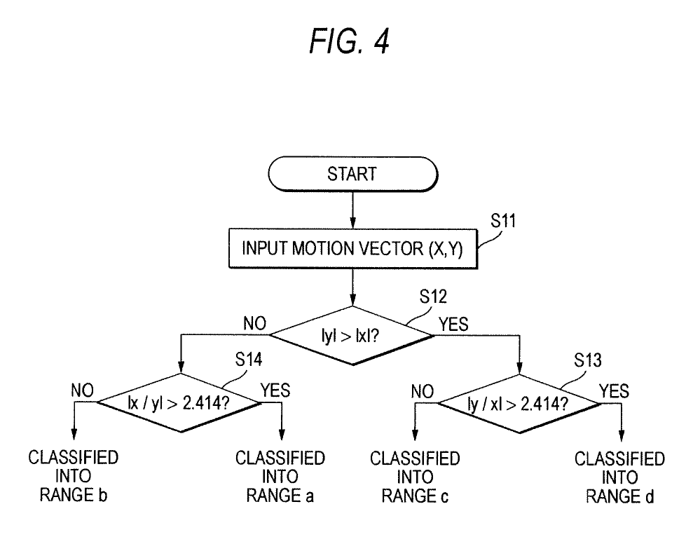

FIG. 4 is a flowchart showing a procedure of a method for classifying the motion vector of each quadrant into further four directional ranges in the intra-quadrant classification unit 22.

If the motion vector (x,y) represented by the horizontal component value x and the vertical component value y is inputted (step S11), it is checked whether or not the absolute value of y is greater than the absolute value of x (|y|>x|) (step S12).

If |y|>|x| (YES), it is checked whether or not the absolute value of y divided x is greater than 2.41412 which is an approximate value of tan(⅜π) (|y/x|>2.41412). If |y/x|>2.1412 (YES), the motion vector is classified into the range d, or if not |y/x|>2.41412 (NO), the motion vector is classified into the range c (step S13).

Also, if not |y|>|x| (NO) at step S12, it is checked whether or not the absolute value of x divided y is greater than 2.41412 which is an approximate value of tan(⅜π) (|x/y|>2.41412). If |x/y|>2.41412 (YES), the motion vector is classified into the range a, or if not |x/y|>2.41412 (NO), the motion vector is classified into the quadrant b (step S14).

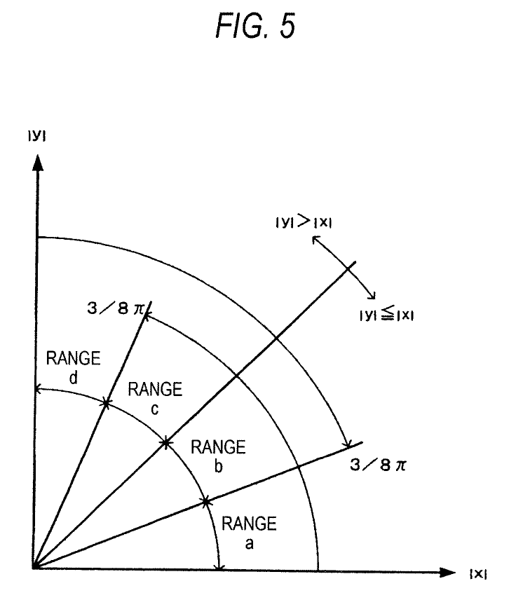

FIG. 5 illustrates the directional ranges of each quadrant classified in accordance with the flow shown in FIG. 4.

In this manner, the motion vector is classified into 16 directional range. This classifications are represented by combinations of quadrants A, B, C and D and directional ranges a, b, c and d, such as A-a, A-b, A-c, A-d, B-d, B-c, B-b, B-a, C-a, C-b, C-c, C-d, D-d, D-c, D-b and D-a. In the motion vector classification unit 2, eight directional ranges having combinations of two out of these 16 directional ranges and given the classification number from 0 to 7 are used for classification.

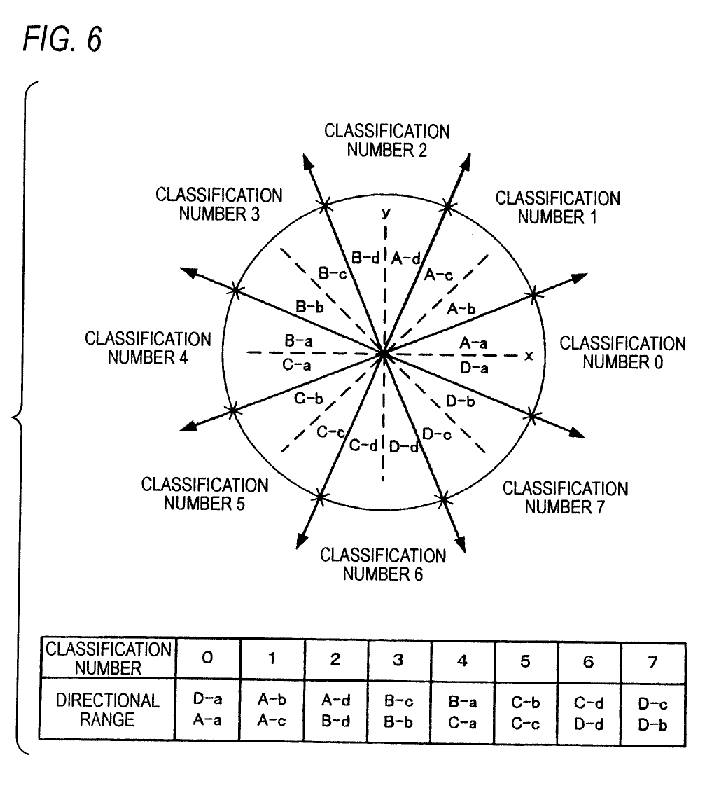

FIG. 6 is a view showing the relationship between the classification of motion vector and the direction of motion vector in the motion vector classification unit 2.

In the motion vector classification unit 2, the motion vector from directional range D-a to A-a is classified into classification number 0; the motion vector from 5directional range A-b to A-c is classified into classification number 1; the motion vector from directional range A-d to B-d is classified into classification number 2; the motion vector from directional range B-c to B-b is classified into classification number 3; the motion vector from directional range B-a to C-a is classified into classification number 4; the motion vector from directional range C-b to C-c is classified into classification number 5; the motion vector from directional range C-d to D-d is classified into classification number 6; and the motion vector from directional range D-c to D-b is classified into classification number 7.

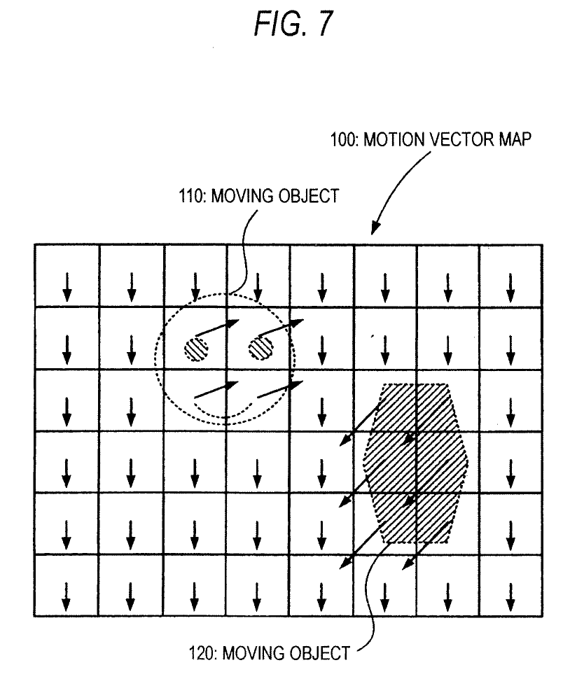

Referring to FIGS. 7-10, the operation of extracting the contour of image block containing a moving object, from the motion vector for every image block in the device according to the embodiment, will be described.

FIG. 7 is a motion vector map 100 representing the motion vector by the arrow to visually clarify the motion vector for every image block in which the motion vectors are arranged in accordance with the arrangement of image blocks. In this motion vector map 100, the image blocks containing the moving object 110 and the moving object 120 indicate the orientation of the arrow different from the peripheral image blocks.

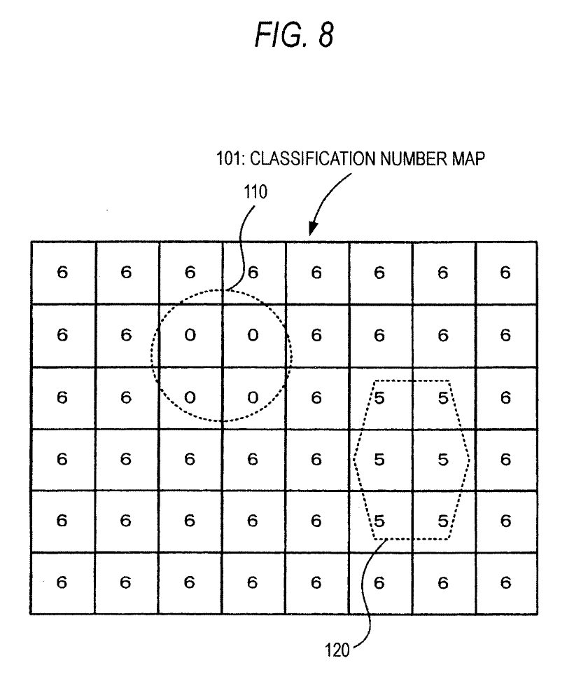

FIG. 8 is a classification number map 101 showing the result in which the motion vector of each image block as shown in FIG. 7 is classified by the motion vector classification unit 2 and given the classification number 10 as shown in FIG. 6.

In the classification number map 101 of FIG. 8, the classification number of the image block containing the moving object 110 is zero, the classification number of the image block containing the moving object 120 is 5, and the classification number of other image blocks is 6.

If the classification number map 101 is generated, the different direction image block extractor 3 scans sequentially the classification numbers listed in the classification number map 101, for example, from the upper left, to extract the image block having the classification number different from the peripheral image blocks.

The image block connector 4 connects the consecutive image blocks, when the image blocks having the same classification number exist consecutively in the extracted image blocks.

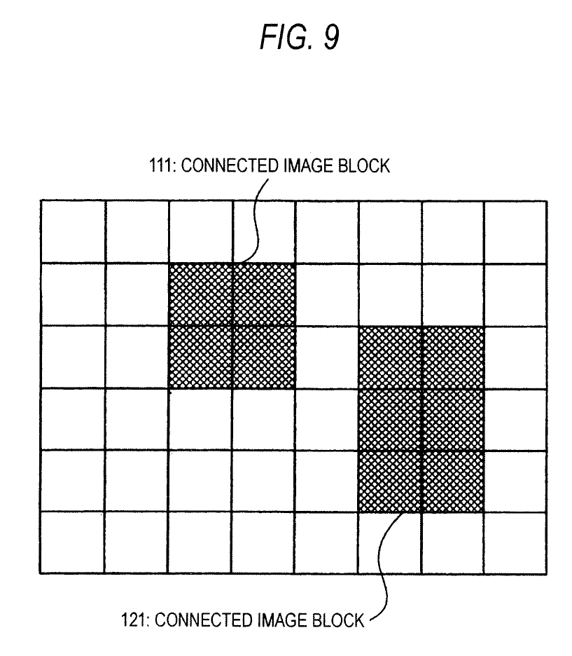

FIG. 9 is a view showing the result of connecting the image blocks in the image block connector 4.

For the classification number map 101, the image block connector 4 generates a connected image block 111 and a connected image block 121.

Subsequently, the contour extractor 5 extracts the line spanning the outermost periphery of each connected image block as the contour data.

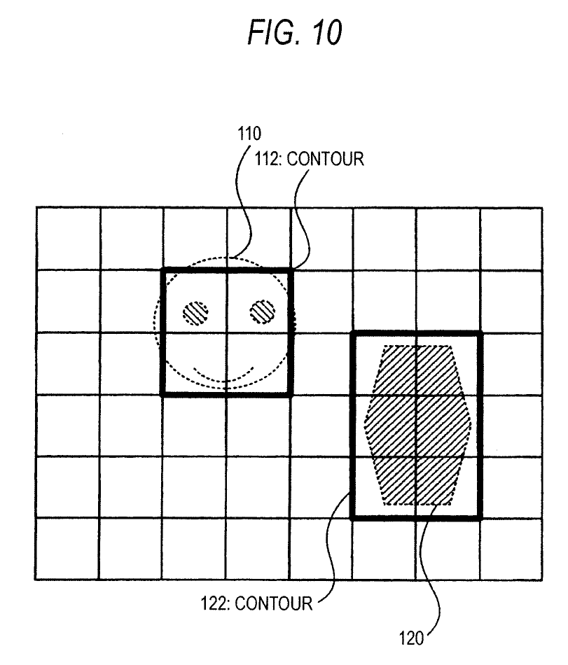

FIG. 10 is a view showing the result of generating the contour data in the contour extractor 5. In FIG. 10, the positions of the moving objects 110 and 120 are shown together.

For the connected image block 111 and the connected image block 121, the contour extractor 5 extracts the contours 112 and 122. As shown in FIG. 10, the contours 112 and 122 extracted by the contour extractor 5 are contours of the image blocks containing the moving objects 110 and 120.

That is, the device of this embodiment can extract the contour of the image block containing the moving object from the motion vector for every image block.

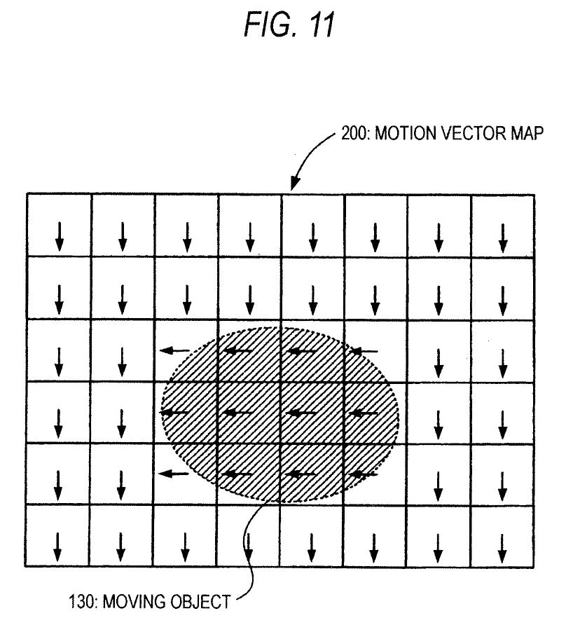

Another example of the moving object contour extraction is shown in FIGS. 11-14.

FIG. 11 is a motion vector map 120 showing the motion vector on an image block basis for the image containing the moving object 130.

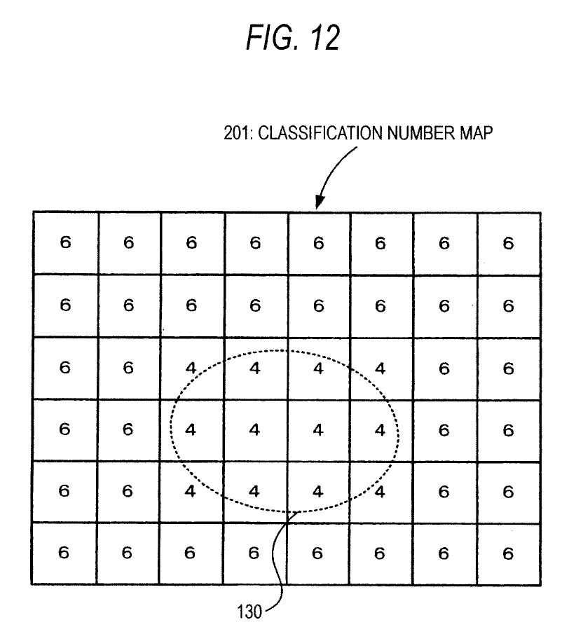

FIG. 12 is a classification number map 201 showing the result that the motion vector of each image block as shown in FIG. 11 is classified by the motion vector classification unit 2 and given the classification number shown in FIG. 6.

In the classification number map 201 of FIG. 12, the classification number of the image block containing the moving object 130 is 4 and the classification number of other image blocks is 6.

If the classification number map 201 is generated, the different direction image block extractor 3 extracts the image block having the different classification number from the peripheral image blocks in the classification number map 201. Then, the image block connector 4 connects the consecutive image blocks, when the image blocks having the same classification number exist consecutively in the extracted image blocks.

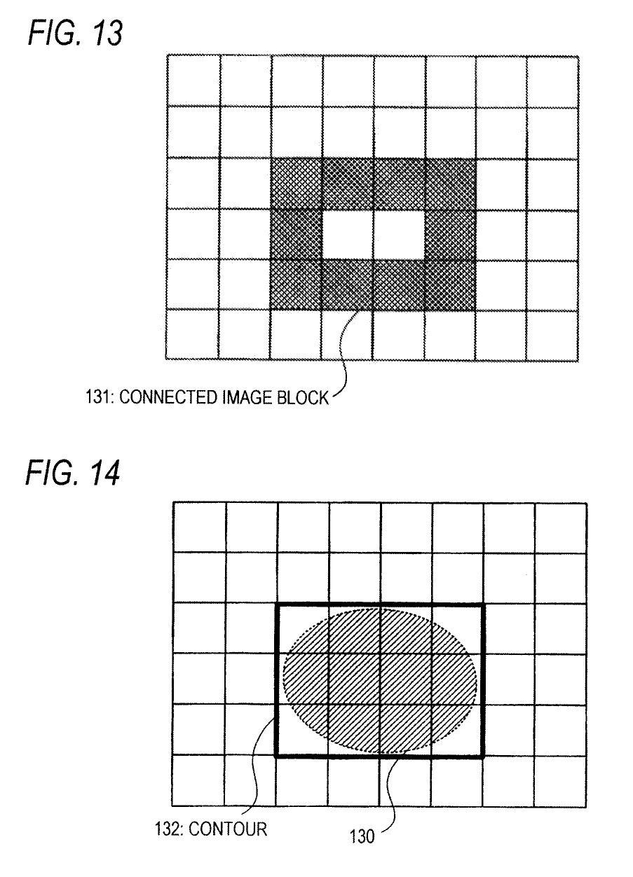

FIG. 13 is a view showing the result of connecting the image blocks in the image block connector 4.

For the classification number map 201, the image block connector 4 generates a connected image block 131. At this time, since the classification number 4 of the motion vector for the image blocks in the central part of the moving object 130 is the same as the classification number of the motion vector for the peripheral image blocks, the connected image block 131 is in the form in which the central part of the moving object 130 is excepted inside.

However, since the contour extractor 5 extracts the line spanning the outermost periphery of the connected image block 131 as the contour data, the contour of the image block containing the moving object 130 can be generated, even if the connected image block 131 is excepted inside.

FIG. 14 is a view showing the result that the contour extractor 5 extracts the contour data of the control 132 for the connected image block 131. In FIG. 14, the position of the moving object 130 is shown together.

As shown in FIG. 14, the contour 132 extracted by the contour extractor 5 is the contour of the image block containing the moving object 130.

That is, the device of this embodiment can extract the contour of the image block containing the moving object, even if there is a wide area of the image containing the moving object, and any image block having the same moving direction as the peripheral image blocks exists in its central part.

As described above in detail, it is possible to extract the contour of the image area encompassing the moving object existing in the compressed and encoded video image data using the motion vector information alone without necessity of completely decoding the compressed and encoded video image data.

What is claimed is:

1. A device for extracting contour of a moving object included in a video image, comprising:
a motion vector decoder that decodes a motion vector on an image block basis in accordance with motion vector information that is generated in compressing and encoding the video image;
a motion vector classification unit that classifies a moving direction of the image block represented by the motion vector into one of a plurality of directional ranges that are preliminarily defined;
a different direction image block extractor that extracts the image block having the classified directional range different from the peripheral image blocks;
an image block connector that connects consecutive image blocks, when any image blocks in same directional range exist consecutively in the extracted image block; and
a contour extractor that extracts the line spanning the outermost periphery of the connected image blocks as contour data that indicates contour of the moving object.

2. The device according to claim 1, wherein the motion vector classification unit includes:
a first classification unit that classifies the motion vector into four quadrants according to a combination of positive and negative of a horizontal component value and a vertical component value of the motion vector; and
a second classification unit that further classifies the motion vector classified into each of the quadrant into a plurality of directional ranges according to the value of a ratio of the absolute values of the horizontal component value and the absolute value of the vertical component value of the motion vector.

3. A method for extracting contour of a moving object included in a video image, comprising:
decoding a motion vector on an image block basis in accordance with motion vector information that is generated in compressing and encoding the video image;
classifying a moving direction of the image block represented by the motion vector into one of a plurality of directional ranges that are preliminarily defined;
extracting the image block having the classified directional range different from the peripheral image blocks;
connecting consecutive image blocks, when any image blocks in same directional range exist consecutively in the extracted image block; and
extracting the line spanning the outermost periphery of the connected image blocks as contour data that indicates contour of the moving object.

4. The method according to claim 3, wherein the step of classifying the moving direction includes:
classifying the motion vector into four quadrants according to a combination of positive and negative of a horizontal component value and a vertical component value of the motion vector; and
classifying the motion vector classified into each of the quadrant into a plurality of directional ranges according to the value of a ratio of the absolute values of the horizontal component value and the absolute value of the vertical component value of the motion vector.

5. The method according to claim 3, wherein the step of extracting the image block includes:
replacing the motion vector of the image block with a number appended to each of the plurality of directional ranges based on the classification;
comparing the number of each of the image blocks with the numbers of the peripheral image blocks; and
extracting the image block having the different number from the numbers of the peripheral image blocks.
